(19) United States
(12) Patent Application Publication
(10) Pub. No.: US 2014/0125581 A1
(43) Pub. Date: May 8, 2014

(54) Individual Task Refocus Device

(71) Applicants: Anil Roy Chitkara, Wayland, MA (US); Michael Ellenbogen, Wayland, MA (US); Elizabeth Reed Herbst Knapp, Wayland, MA (US)

(72) Inventors: Anil Roy Chitkara, Wayland, MA (US); Michael Ellenbogen, Wayland, MA (US); Elizabeth Reed Herbst Knapp, Wayland, MA (US)

(21) Appl. No.: 14/070,409

(22) Filed: Nov. 1, 2013

Related U.S. Application Data
(60) Provisional application No. 61/721,953, filed on Nov. 2, 2012.

(51) Int. Cl. G06F 3/01

(52) U.S. Cl. CPC G06F 3/013
USPC 345/156

(57) ABSTRACT

The subject matter disclosed herein provides methods for detecting a user's loss of focus while reading content from an electronic device, paper, or other medium and prompting the user to refocus his/her concentration. This method can maintain a user profile that includes alert parameters. The alert parameters can include a prompt timer period and a type of prompt to be generated. The prompt timer period can specify a maximum allowable gaze time before one or more prompts are generated. The method can determine whether data received from a device tracking a movement by one or both eyes of a user is representative of active reading of content viewed by the user. One or more prompts can be generated based on the determining. Related apparatus, systems, techniques, and articles are also described.

### CROSS REFERENCE TO RELATED APPLICATIONS

The current application claims priority under 35 U.S.C. §119(e) to U.S. Provisional Patent Application No. 61/721,953 filed on Nov. 2, 2012, entitled “Individual Task Refocus Device”, the contents of which are incorporated herein by reference in their entirety for all purposes.

### TECHNICAL FIELD

This disclosure relates generally to detecting a user's loss of focus while reading content from an electronic device, paper, or other medium and, in some implementations, to prompting the user to refocus his/her concentration.

### BACKGROUND

Computers, mobile devices, tablets, and e-books are widely used by the general population in a variety of contexts. People undertaking individual tasks that require extended periods of attentiveness using these devices, such as reading, completing homework assignments, or writing, can easily lose their focus as a result of external distractions or loss of concentration. For some people, this loss of focus can stem from a variety of reasons including, for example, attention deficit disorder (ADD) and/or attention deficit hyperactivity disorder (ADHD).

### SUMMARY

In some implementations, methods and apparatus, including computer program products, are provided for detecting a user's loss of focus while reading content from an electronic device, paper, or other medium and prompting the user to refocus his/her concentration.

In one aspect, a user profile is maintained. The user profile includes alert parameters. The alert parameters include a prompt timer period and a type of prompt to be generated. The prompt timer period specifies a maximum allowable gaze time before one or more prompts are generated. It is determined whether data received from a device tracking a movement by one or both eyes of a user is representative of active reading of content being viewed by the user. One or more prompts are generated based on the determining.

The above methods, apparatus, and computer program products can, in some implementations, further include one or more of the following features.

The data can be representative of active reading when one or both eyes of the user move.

The user profile can further include or more user goals and user information.

Data regarding the one or more user goals can be received. The one or more user goals can include one or more of a target cumulative active reading time, a target session active reading time, a target number of prompts per session, and a target time interval between the generating of successive prompts.

Data regarding the user information can be received. The user information can include one or more of a name of the user, an age of the user, a reading level of the user, and an account type of the user.

The user information can further include a point total. The point total can be increased by one or more predetermined values when any of the one or more user goals are achieved. A message can be displayed when any of the one or more user goals are achieved.

A new prompt timer period for the user can be proposed based on one or more of the reading level of the user and a number of previously generated prompts.

One or both eyes of the user can be gazing when one or both eyes of the user are not moving. The prompt timer period can be reset upon detecting movement of one or both eyes of the user.

The determining of whether the received data is representative of active reading can also be based on a type of the content being viewed by the user. The data can be representative of active reading when one or both eyes of the user do not move during the prompt timer period and the type of the content is a chart, a graph, a picture, or a drawing.

The type of prompt can include an audible alert, a vibration, a flash of light on a display screen, and a pop-up window on the display screen. The one or more prompts can be generated upon expiration of the prompt timer period.

One or more reports relating to one or more users can be generated. The one or more reports can identify one or more of a cumulative active reading time for each user, a session active reading time for each user, a longest uninterrupted session for each user, and an average time interval between generation of successive prompts for each user. The one or more reports can be sent to one or more individuals.

A game can be created between at least one other user and the user. The game can compare one or more metrics associated with the user and the at least one other user. The one or more metrics can be collected from user profiles associated with the user and the at least one other user. A sorted list of the one or more metrics can be published. The sorted list can be accessible only by the user and the at least one other user. The one or more metrics can include a cumulative active reading time, a session active reading time, a longest uninterrupted session, and an average time interval between generation of successive prompts.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIGS. 1A, 1B, 1C, and 1D illustrate an electronic device, in accordance with some example implementations;

FIG. 2 illustrates a user profile, in accordance with some example implementations;

FIG. 3 illustrates a process for using a task refocus application based on the interaction of a student with an electronic device, in accordance with some example implementations;

FIG. 4A illustrates a process for using the task refocus application based on the interaction of an administrator with an electronic device, in accordance with some example implementations;

FIG. 4B illustrates a user interface that can be used with the process of FIG. 4A, in accordance with some example implementations; and

FIG. 5 illustrates a process for determining whether a user is actively reading and displaying a prompt based on this determination, in accordance with some example implementations.

Like reference symbols in the various drawings indicate like elements.

### DETAILED DESCRIPTION

This application discloses techniques for refocusing the attention of a user engaged in tasks that require focused attention. An electronic device can generate or receive from another device data relating to tracking the movement of a user's eyes and can analyze this data to determine whether the user is actively reading content, which can include content displayed on the electronic device and/or other content, such as for example printed material (e.g. in a book, a magazine, a textbook, printed pages, content displayed in another electronic device, etc.). Based on this determination, the electronic device can generate one or more prompts. These prompts can alert the user that he/she has lost focus.

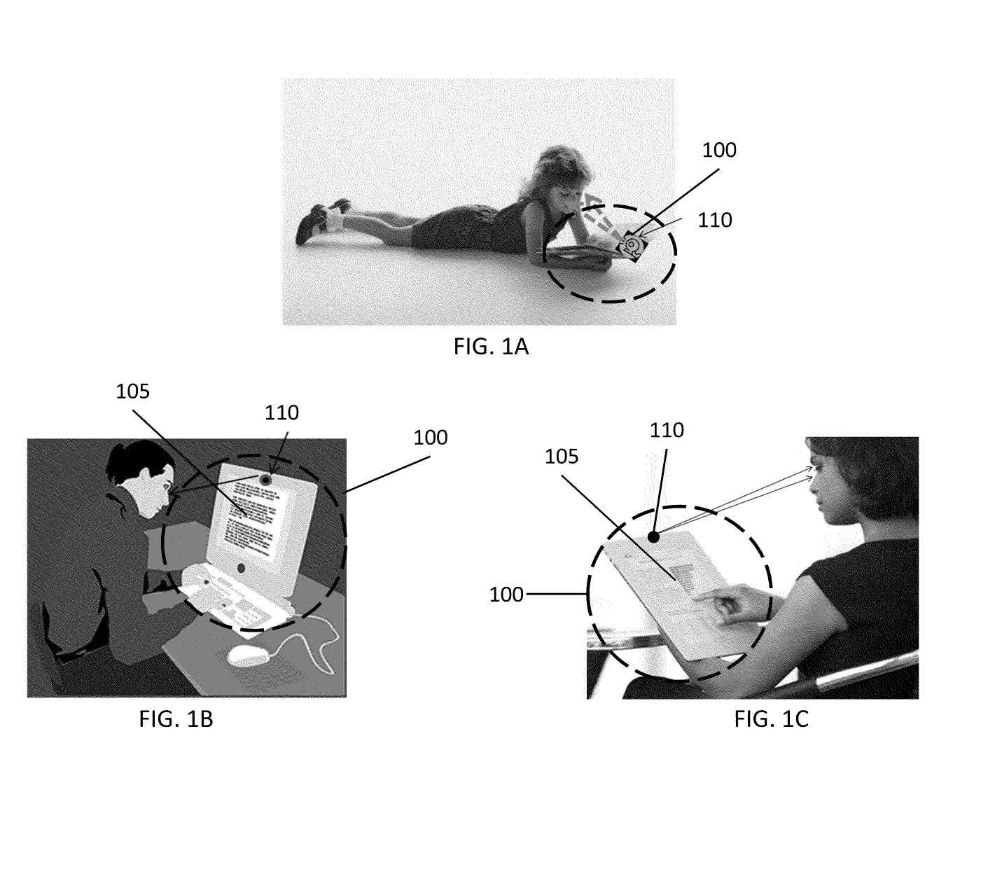

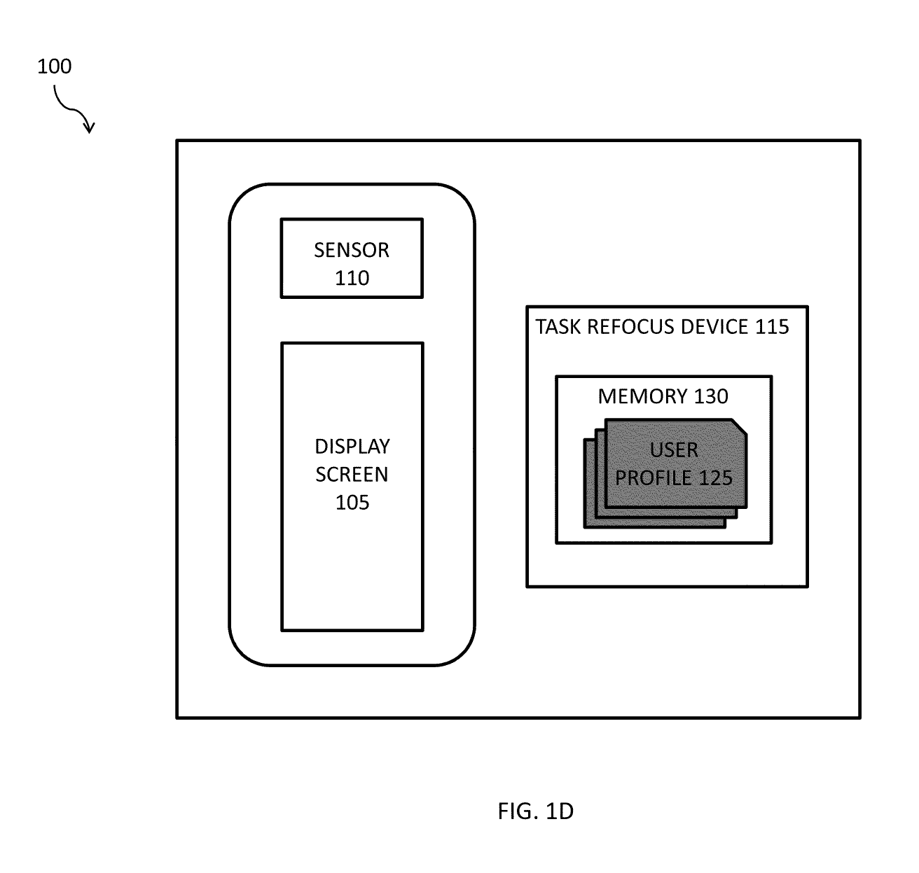

FIGS. 1A, 1B, and 1C illustrate examples of an electronic device 100 that can be used with the apparatus, methods, and systems disclosed herein. As used herein, an electronic device 100 can include a general purpose computing device such as a desktop or laptop computer, a tablet computing device, a smart phone, and the like. Such a device can include a display screen 105 and can either include or receive data from a sensor 110, which can be a digital camera or other device for tracking motion of a user's eyes. In other implementations of the current subject matter, the electronic device 100 can be a specific use device, such as for example a device that includes or receives data from a sensor 110 and that includes one or more of electronic circuitry, a processor executing code, and the like to perform operations discussed herein. For example, as shown in FIG. 1A, the electronic device 100 can include a sensor 110 and can be used to monitor a user's attentiveness or concentration while viewing content displayed externally to the electronic device (e.g. in a book or other printed material, on a display screen of another electronic device, etc.). For simplicity, various features of the current subject matter are discussed herein in association with an electronic device 100 that includes a display screen 105 upon which content viewed by a user is displayed. However, these descriptions are not meant to be limiting. An electronic device 100 consistent with implementations of the current subject matter can also be used to monitor concentration or attentiveness of a user viewing content other than on a display screen 105 of the electronic device 100.

As discussed in further detail below, the electronic device 100 can run a task refocus application that can prompt a user to concentrate when the user loses focus while reading content displayed on the electronic device 100. A task refocus application consistent with implementations of the current subject matter can also or alternatively perform tasks other than or in addition to prompting a user to concentrate.

As illustrated in the functional block diagram of FIG. 1D, an electronic device 100 consistent with some implementations of the current subject matter can include a display screen 105 that displays reading content. This reading content can include text, graphs, figures, photos, drawings, and the like. As a user reads content from display screen 105, sensor 110 can detect whether one or more of the user's eyes are moving. In some implementations, sensor 110 can be a video camera that captures images of the user's eyes. Although FIG. 1 illustrates sensor 110 as residing within or otherwise being integral to electronic device 100, an external sensor can also be used (e.g., an external sensor attached to electronic device 100 and directed at the user's eyes). Sensor 110 can send the captured images to a task refocus device 115 which, in turn, can process the received images to determine whether the user is actively reading the content displayed on the display screen 105 or other content. Task refocus device 115 can include a programmable processor executing software or other code to perform one or more operations discussed herein. Alternatively or in addition, the task refocus device 115 can include other computing hardware.

A user can be determined to be actively reading if one or both of the user's eyes are moving. Task refocus device 115 can use the images received from sensor 110 to make this determination. In some implementations, task refocus device 115 can examine the position of the user's pupils in successive images. If the user's pupils appear in different positions in these images, then task refocus device 115 can infer that the user's eyes are moving. For example, sensor 110 can capture the movement of the user's pupils as they move from left to right as the user reads a line of text.

Likewise, if the user's pupils remain in the same position in successive images, then task refocus device 115 can infer that the user's eyes are not moving. Under these circumstances, the user may be gazing at display screen 105 or looking away from the display screen. Both scenarios are generally indicative of a loss of focus or concentration. For example, a user can blindly gaze or stare at a screen of text without actively reading the text. However, if the user is gazing or staring at a chart on display screen 105, the user may be studying the chart (i.e., there may be no loss of focus) notwithstanding the lack of movement by his/her eyes. Task refocus device 115 can be configured to consider the type of content displayed on display screen 105 when determining whether a user is actively reading. In addition to eye movement, other features can be tracked to determine whether the user is actively reading including, for example, pupil dilation, eye luminosity, eyelid separation, a divergence of right and left eye directions, blink duration and frequency, saccade, and the like. Sensor 110 and task refocus device 115 can be configured to track and analyze any of these features in a variety of conditions including, for example, when a user is wearing corrective lenses (e.g., eyeglasses, sunglasses, and contact lenses), in different lighting conditions (e.g., when there is no ambient light or outdoors on a sunny day), when there is movement behind the user, when the user shifts his/her body, and the like.

Electronic device 100 can be used in variety of settings by one or more users. For example, parents can use electronic device 100 to track the amount of time that their children are actively reading. School instructors can use electronic device 100 to monitor their students' reading. In order to keep track of each individual's reading progress, electronic device 100 can store a user profile 125 for each user in memory 130 (e.g. any kind of machine readable storage device). Memory 130 can reside within task refocus device 115. In some implementations, user profiles 125 can be stored in a database that can be remotely accessed by task refocus device 115 via a network connection.

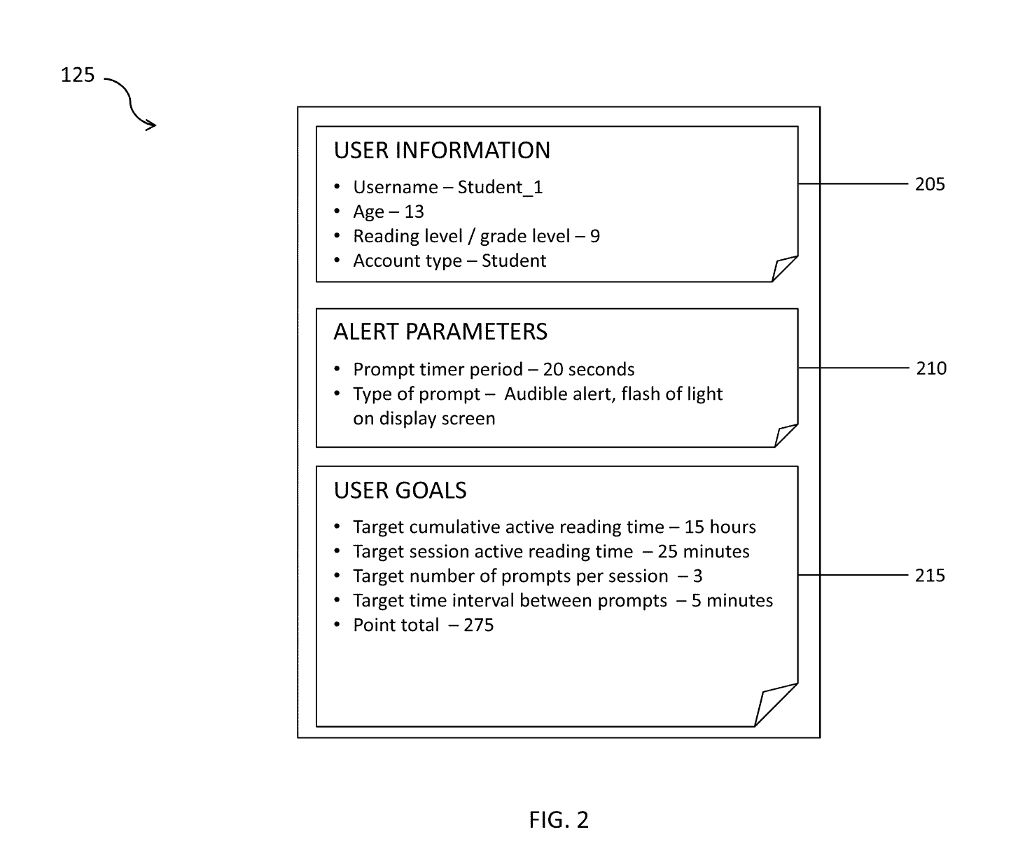

FIG. 2 illustrates a user profile 125 that can include user information 205, alert parameters 210, and user goals 215. A user can enter values for each field using an input device attached to electronic device 100 such as a keyboard, a virtual keyboard displayed on display screen 105, a microphone that converts speech-to-text, and the like.

User information 205 can store biographical information. Biographical information can include one or more of a user's name, age, reading level, and the like. A user's reading level can correspond to the user's educational stage (e.g., a grade level) or the educational stage that best represents the user's reading abilities. User information 205 can also indicate the account type associated with the user. This account type can specify whether the user is a student or an administrator. A student can use the electronic device to monitor his/her own progress. An administrator can monitor the progress of any student and can set various alert parameters and generate reports as described below. An administrator can be, for example, a parent or a teacher.

Alert parameters 210 can identify when and how a prompt should be generated when a user begins to lose his/her focus. Alert parameters 210 can include a prompt timer period and a prompt type. The prompt timer period can specify the maximum allowable gaze time before a prompt is generated and can range from 5 seconds to 60 seconds. As described above, lack of eye movement can be associated with gazing. If, for example, the prompt timer period is set for 20 seconds and task refocusing device 115 determines that the user is gazing at the screen during this entire time (i.e., not actively reading), then the task refocusing device can generate a prompt alerting the user to focus when the prompt timer period expires. If, however, task refocusing device 115 detects eye movement, then the prompt timer period can be reset. Task refocusing device 115 can generate different types of prompts including one or more of an audible alert (e.g., a simulated or actual recorded voice or other sound), a vibration, a flash of light on display screen 105, or a pop-up window with a message on the display screen. Both students and administrators can specify the desired prompt timer period and prompt type.

User goals 215 can be associated with reading achievements. If a user wants to track his/her total reading time, the user can specify a target cumulative active reading time or a target session active reading time. With regard to the former, task refocus device 115 can record the user's total active reading time during the current reading session as well as all previous reading sessions. With regard to the latter, task refocus device 115 can record the user's total active reading time during the current reading session. A reading session can begin after the user has logged into the task refocus application, and display screen 105 has started displaying reading content. A reading session can end when the user closes the application. User goals 215 can also include prompt related goals. For example, if a user is trying to decrease the number of prompts that are generated during a reading session or decrease the frequency at which they are generated, he/she can specify a target number of prompts during a reading session or a target time interval between the generation of successive prompts, respectively.

Task refocus device 115 can track a user's progress towards these goals during the user's reading session and store data regarding the same in user profile 125. User profile 125 can also store historical data from previous reading sessions. For example, in order for task refocus device 115 to determine whether the user has met his/her target cumulative active reading time, the task refocusing device can access the user's profile to determine the active reading time from previous reading sessions and add this value to the active reading time from the current reading session. Task refocus device 115 can be configured to check for goal achievements when the task refocus application is closed. If a goal has been met, task refocus device 115 can cause display screen 105 to display a congratulatory message (e.g., “Congratulations! You achieved your goal!”) or other customizable message (e.g., displaying an image of a trophy, coins, etc.).

In some implementations, task refocus device 115 can implement a reward mechanism to reward users for achieving their goals with points. Point allocations can be set by an administrator and stored in memory 130. When a user achieves a user goal 215, task refocus device 115 can increase the user's point total by the allocated point amount. User profile 125 can store the user's point total with goals 215.

This reward mechanism can be customized in different ways. For example, instead of increasing a user's point total only when he/she has achieved a goal, task refocus device 115 can award points as the user makes progress towards his/her goal. If, for example, the completion or achievement of a particular goal (e.g., target cumulative reading time of 100 hours) is worth 100 points, then task refocus device 115 can increase the user's point total by 50 points when the goal is halfway complete (e.g., the user reaches a cumulative reading time of 50 hours). A user can also be rewarded if he/she uses the task refocus application for a particular number of consecutive days. In some implementations, a user can cash-in his/her points for a tangible reward or cash value. For example, an administrator can reward a user with a $50 gift card if the user has accumulated 1,000 points. Providing these rewards can incentivize the user to utilize the task reading application.

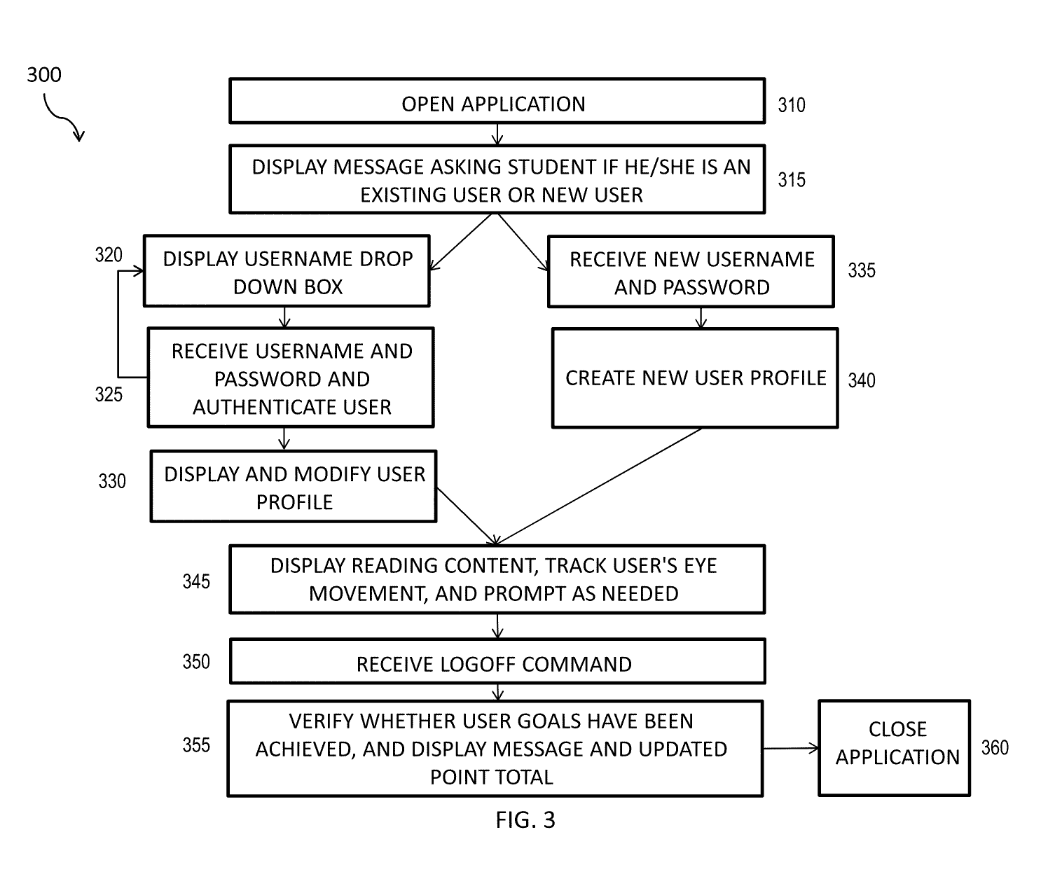

FIG. 3 illustrates a process 300 for using the task refocus application. The steps of process 300 can be based on the interaction of a student with electronic device 100. At 310, task refocus device 115 can open or launch the task refocus application. At 315, display screen 105 can display a message asking the student if he/she is an existing user (i.e., has an existing user profile 125) or a new user.

If the student is an existing user, processing proceeds to 320. At 320, display screen 105 can display a drop down box with various usernames. The student can select his/her username from the drop down box and enter his/her password. Task refocus device 115 can receive this information and authenticate the student at 325. If task refocus device 115 is unable to authenticate the student, processing proceeds back to 320. After a predetermined number of unsuccessful login attempts, the task refocus application can close the application. Once the student is authenticated, display screen 105 can display the student's user profile at 330. The student can review and/or modify any of the information in his/her profile. For example, the student can update his/her age in user information 205, adjust the prompt timer period in alert parameters 210, and change his/her target session active reading time in user goals 215. In some implementations, task refocus device 115 can propose a new prompt timer period for the student based on the student's reading level. For example, if the average prompt timer period for a student in the third grade is 20 seconds, then task refocus device 115 can propose a 20 second value to all students in the third grade. Task refocus device 115 can also propose a new prompt timer period based on the student's reading behavior. For example, if a student previously received 2 prompts during a 30 minute reading session when his/her prompt timer period was set at 50 seconds, then task refocus device 115 can infer that the prompt timer period is too high and, consequently, propose a lower prompt timer period (e.g., 40 seconds). Once these changes are saved to user profile 125, processing can proceed to 345.

Returning to 315, if the student indicates that he/she is a new user, processing can proceed to 335. At 335, the student can enter a new username and password. At 340, task refocus device 115 can create a new user profile 125 and prompt the student to provide values for user information 205, alert parameters 210, and user goals 215. Task refocus device 115 can save new user profile 125 to memory 130, and processing can proceed to 345.

At 345, task refocus device 115 can cause display screen 105 to display reading content appropriate for the user's reading level. As the student reads, sensor 110 can capture and send images of the user's eyes to task refocus device 115. Task refocus device 115 can process these images to determine whether the student is actively reading as described above. If, for example, task refocus device 115 determines that the student is not actively reading and his/her prompt timer period has expired, then task refocus device 115 can generate a prompt in accordance with the values specified in alert parameters 210.

In some implementations, task refocus device 115 can display an “Ignore” button on display screen 105 after a prompt is generated. A student can select the “Ignore” button to temporarily suspend the generation of prompts. This feature can be useful if, for example, the student is looking at a chart, a graph, a picture, or a drawing on display screen 105. As explained above, the student may be actively reading or studying the image even though his/her eyes are not moving. When the “Ignore” button is pressed, task refocus device 115 can suspend prompt generation so long as the image is displayed on display screen 105. Once the student moves to a different page, task refocus device 115 can resume generating prompts as previously described. The “Ignore” button can be enabled or disabled by an administrator. In some implementations, task refocus device 115 can cause the “Ignore” button to be displayed only when a chart, a graph, a picture, or a drawing is displayed on display screen 105.

At 350, task refocus device 115 can receive a logoff command from the student. A student can logoff when he/she has completed a reading session. Sometimes, however, a student may prematurely logoff if he/she becomes frustrated with the application's prompts. In order to prevent this scenario from occurring, an administrator can enable task refocus device 115 to lock a reading session. When this feature is enabled, a student may be required to enter a password in order to log off or close the application before processing can proceed to 355.

Task refocus device 115 can determine whether any of the student's goals 215 have been achieved at 355. If none of these goals have been achieved, then processing can proceed to 360, and the task refocus application can close. If, however, the student has achieved one or more goals, then display screen 105 can display a congratulatory message or other customized message at 355. If the achieved goals are eligible for points, then task refocus device 115 can update the student's point total, and display screen 105 can display the updated point total. The task refocus application can close at 360.

Additional features can be incorporated into process 300. In some implementations, for example, the task refocus application can be configured to display one or more comprehension questions upon receiving a logoff command at 345. A student may be required to answer these questions before the task refocus application can be closed. This optional feature is useful for students with ADD or other attention issues. While these students may move their eyes as they read, they may not be able to absorb or comprehend the material. When this feature is enabled by an administrator, task refocus device 115 can prompt the student to answer one or more standard questions and/or customized questions regarding the material. The standard questions could, for example, ask “Do you remember all the details of what you just read? If not, please take a minute to go back and review it.” Customized questions can be directly related to the text and ask questions regarding a particular character's actions or motivations, details about the story, writing technique, and the like.

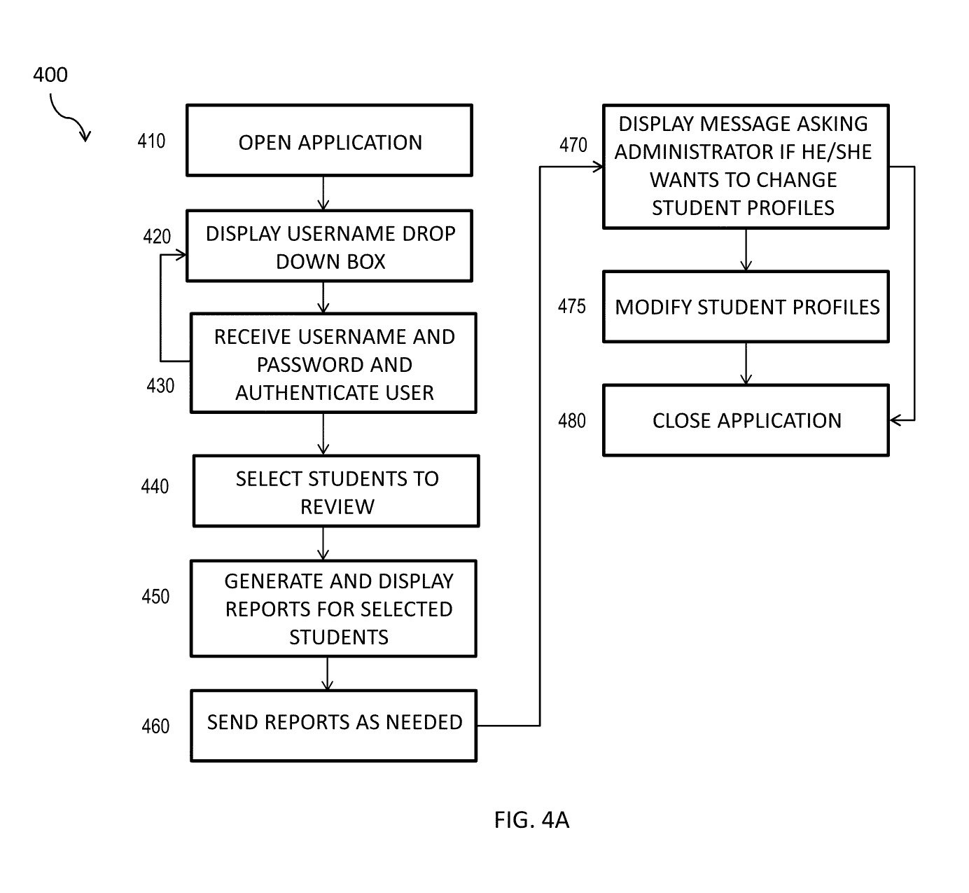

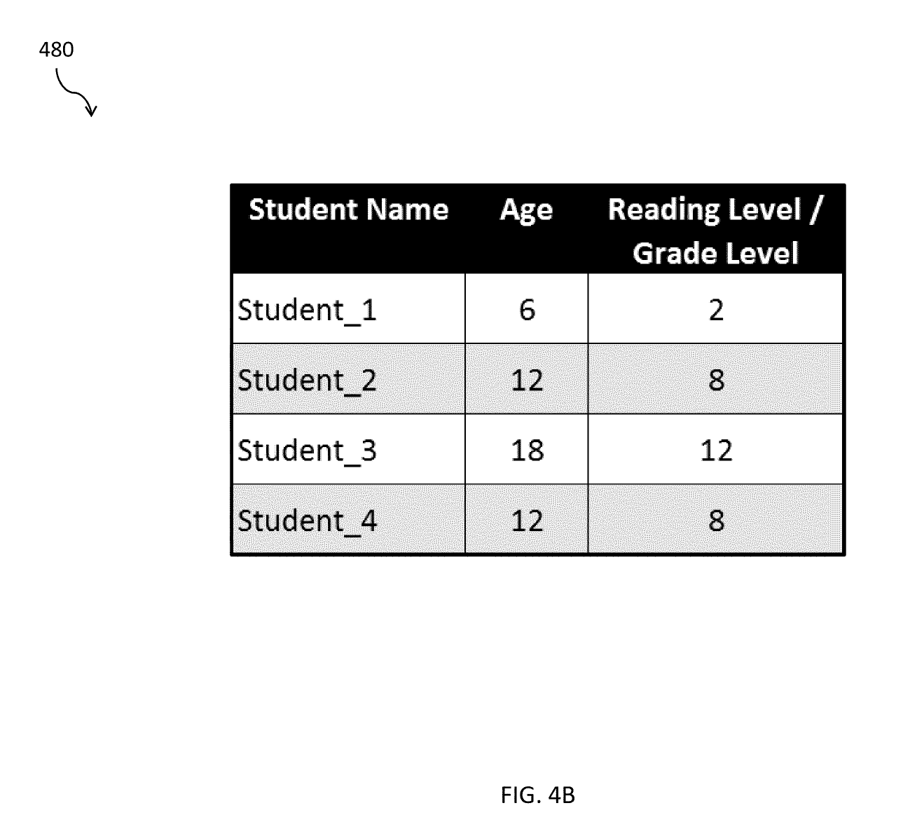

FIG. 4A illustrates a process 400 for using the task refocus application. The steps of process 400 can be based on the interaction of an administrator with electronic device 100. At 410, task refocus device 115 can open or launch the task refocus application. At 420, display screen 105 can display a drop down box with various usernames. The administrator can select his/her username from the drop down box and enter his/her password. Task refocus device 115 can receive this information and authenticate the administrator at 430. If task refocus device 115 is unable to authenticate the administrator, processing proceeds back to 420. After a predetermined number of unsuccessful login attempts, the task refocus application can close the application.

At 440, task refocus device 115 can prompt the administrator to indicate which students he/she wants to review. In some implementations, display screen 105 can display user interface 480 illustrated in FIG. 4B to facilitate the selection process. User interface 480 can display a list of students along with each student's name, age, and reading level (or grade level). Task refocus device 115 can generate user interface 480 by extracting user information 205 from each student's user profile 125. The administrator can select students by clicking or tapping on each student's name. In the example of FIG. 4B, the administrator has selected to review the progress reports of Student_2 and Student_4.

At 450, task refocus device 115 can generate and display progress reports for the students selected at 440. These progress reports can identify one or more of a student's metrics relating to the student's reading results. For example, these metrics can include cumulative active reading time, session active reading time, the longest uninterrupted session (i.e., without prompts), and average time between generation of successive prompts. The reported data can be used for evaluation of reading curricula, teacher efficacy, standardized testing, or intervention efforts. For example, an administrator can use these progress reports to determine whether reading interventions being used on a student on an individualized education plan are working If desired, the administrator can request task refocus device 115 to send these reports at 460. These reports can be sent by e-mail, text message, or fax to the student's parents or other school personnel.

At 470, display screen 105 can display a message asking the administrator whether he/she would like to change the profiles of the students selected at 440. If changes are not needed, then processing can proceed to 480, and the task refocus application can close. However, if changes are needed, then processing can proceed to 475. For example, after the administrator has reviewed the progress report of Student_2, the administrator can decide that this student's prompt timer period should be decreased. In order to change this alert parameter 210, task refocus device 115 can retrieve user profile 125 for Student_2 and display the profile on display screen 105. At 475, the administrator can modify the prompt timer period on the student's profile and save these changes. Once these changes are saved, processing can proceed to 480, and the task refocus application can close.

While the implementation of FIGS. 4A and 4B describes the tracking of student metrics for reporting purposes, these metrics can be used in other contexts. For example, students can share their metrics with each other to simulate a competition or game. Gamification techniques leverage people's natural desire for competition and achievement by applying game mechanics in a non-game context. In order to gamify the reading process, students can participate in games to share their reading results or metrics. Students can create new games, join existing games set up by someone else, or join games open to the public. When a student is participating in a game, electronic device 100 can automatically send a student's metrics to a social media website or other dedicated gaming application for tracking and publication. These metrics can be stored in each student's profile, and electronic device 100 can automatically send this data when the student logs off the task refocus application or at predetermined intervals during a reading session. Upon collecting this data, the social media website or dedicated gaming application can publish game results including, for example, a top ten list of students with the longest cumulative active reading time, a top ten list of students with the longest uninterrupted session, and the like. These game results can be made publicly available or accessible only to the game's participants. An administrator can select which metrics to track with regard to the compilation of game results. In some implementations, students can propose games based on specific reading passages, reading session time (e.g., who can read the most pages in 30 minutes), and the like. In some implementations, task refocus device 115 (instead of a social media website) can execute processes that allow it to collect and publish these metrics as described above for gaming purposes.

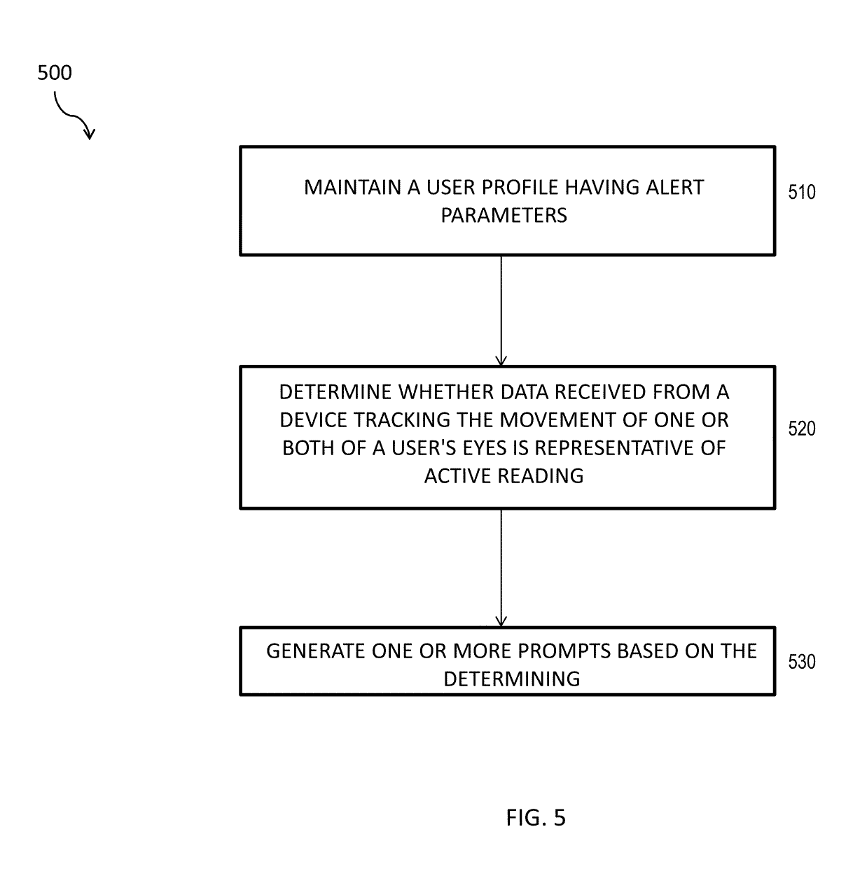

FIG. 5 illustrates a process 500 for determining whether a user is actively reading and for displaying a prompt based on this determination.

At 510, task refocus device can maintain a user profile. In some implementations, the user profile can include one or more alert parameters. These alert parameters can include a prompt timer period and a prompt type. The prompt timer period can specify the maximum allowable gaze time before a prompt is generated.

At 520, task refocus device 115 can receive data from a device tracking the movement of a user's eyes. In some implementations, the tracking device can be sensor 110. The data received from sensor 110 can include images of a user's eyes. Task refocus device 115 can process these images to determine whether the user eyes are moving (i.e., actively reading). If the user's eyes are not moving, then task refocus device 115 can determine that the user is gazing or looking away from display screen 105 (i.e., not actively reading). In some implementations, task refocus device 115 can consider the type of content displayed on display screen 105 (e.g., text, chart, picture, drawing) when making this determination.

At 530, task refocus device 115 can generate a prompt based on the determination made at 510. In some implementations, this prompt can be generated when the prompt timer period has expired. This prompt can be, for example, an audible alert, a vibration, a flash of light on the display screen, or a pop-up window on the display screen.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

What is claimed is:

1. A non-transitory computer-readable medium containing instructions to configure a processor to perform operations comprising:
maintaining a user profile for a user, the user profile comprising alert parameters, the alert parameters comprising a prompt timer period and a type of prompt to be generated, the prompt timer period specifying a maximum allowable gaze time before one or more prompts are generated;
determining whether data received from a device tracking a movement by one or both eyes of the user is representative of active reading of content being viewed by the user; and
generating the one or more prompts based on the determining.

2. The non-transitory computer-readable medium of claim 1, wherein the data is representative of active reading when one or both eyes of the user move.

3. The non-transitory computer-readable medium of claim 1, wherein the user profile further comprises one or more user goals and user information.

4. The non-transitory computer-readable medium of claim 3, the operations further comprising:
receiving data regarding the one or more user goals, the one or more user goals comprising one or more of a target cumulative active reading time, a target session active reading time, a target number of prompts per session, and a target time interval between the generating of successive prompts.

5. The non-transitory computer-readable medium of claim 3, the operations further comprising:
receiving data regarding the user information, the user information comprising one or more of a name of the user, an age of the user, a reading level of the user, and an account type of the user.

6. The non-transitory computer-readable medium of claim 5, wherein the user information further comprises a point total, and
wherein the operations further comprise:
increasing the point total by one or more predetermined values when any of the one or more user goals are achieved; and
displaying a message when any of the one or more user goals are achieved.

7. The non-transitory computer-readable medium of claim 5, the operations further comprising:
proposing a new prompt timer period for the user based on one or more of the reading level of the user and a number of previously generated prompts.

8. The non-transitory computer-readable medium of claim 1, wherein one or both eyes of the user are gazing when one or both eyes of the user are not moving, and
wherein the prompt timer period is reset upon detecting movement of one or both eyes of the user.

9. The non-transitory computer-readable medium of claim 1, wherein the determining is further based on a type of the content being viewed by the user, and
wherein the data is representative of active reading when one or both eyes of the user do not move during the prompt timer period and the type of the content is a chart, a graph, a picture, or a drawing.

10. The non-transitory computer-readable medium of claim 1, wherein the type of prompt comprises an audible alert, a vibration, a flash of light on a display screen, and a pop-up window on the display screen, and
wherein the one or more prompts are generated upon expiration of the prompt timer period.

11. The non-transitory computer-readable medium of claim 1, the operations further comprising:
generating one or more reports relating to one or more users, the one or more reports identifying one or more of a cumulative active reading time for each user, a session active reading time for each user, a longest uninterrupted session for each user, and an average time interval between generation of successive prompts for each user; and
sending the one or more reports to one or more individuals.

12. The non-transitory computer-readable medium of claim 1, the operations further comprising:
creating a game between at least one other user and the user, the game comprising comparing one or more metrics associated with the user and the at least one other user;
collecting the one or more metrics from user profiles associated with the user and the at least one other user; and
publishing a sorted list of the one or more metrics, the sorted list accessible only by the user and the at least one other user.

13. The non-transitory computer-readable medium of claim 12, wherein the one or more metrics comprise a cumulative active reading time, a session active reading time, a longest uninterrupted session, and an average time interval between generation of successive prompts.

14. A method comprising:
maintaining a user profile for a user, the user profile comprising alert parameters, the alert parameters comprising a prompt timer period and a type of prompt to be generated, the prompt timer period specifying a maximum allowable gaze time before one or more prompts are generated;
determining whether data received from a device tracking a movement by one or both eyes of the user is representative of active reading of content being viewed by the user; and
generating the one or more prompts based on the determining.

15. The method of claim 14, wherein one or both eyes of the user are gazing when one or both eyes of the user are not moving, and
wherein the prompt timer period is reset upon detecting movement of one or both eyes of the user.

16. The method of claim 14, wherein the type of prompt comprises an audible alert, a vibration, a flash of light on a display screen, and a pop-up window on the display screen, and
wherein the one or more prompts are generated upon expiration of the prompt timer period.

17. The method of claim 14 further comprising:
creating a game between at least one other user and the user, the game comprising comparing one or more metrics associated with the user and the at least one other user;
collecting the one or more metrics from user profiles associated with the user and the at least one other user; and
publishing a sorted list of the one or more metrics, the sorted list accessible only by the user and the at least one other user.

18. A system comprising:
a processor; and
a memory, wherein the processor and the memory are configured to perform operations comprising:
maintaining a user profile for a user, the user profile comprising alert parameters, the alert parameters comprising a prompt timer period and a type of prompt to be generated, the prompt timer period specifying a maximum allowable gaze time before one or more prompts are generated;
determining whether data received from a device tracking a movement by one or both eyes of the user is representative of active reading of content being viewed by the user; and
generating the one or more prompts based on the determining.

19. The system of claim 18, wherein one or both eyes of the user are gazing when one or both eyes of the user are not moving,
wherein the prompt timer period is reset upon detecting movement of one or both eyes of the user,
wherein the type of prompt comprises an audible alert, a vibration, a flash of light on a display screen, and a pop-up window on the display screen, and
wherein the one or more prompts are generated upon expiration of the prompt timer period.

20. The system of claim 18, the operations further comprising:
creating a game between at least one other user and the user, the game comprising comparing one or more metrics associated with the user and the at least one other user;
collecting the one or more metrics from user profiles associated with the user and the at least one other user; and
publishing a sorted list of the one or more metrics, the sorted list accessible only by the user and the at least one other user.
